(19) United States
(12) Patent Application Publication
(10) Pub. No.: US 2025/0083165 A1
(43) Pub. Date: Mar. 13, 2025

(54) Dispensing System

(71) Applicant: AS Strömungstechnik GmbH, Ostfildern (DE)

(72) Inventors: Andreas Szeteli, Filderstadt (DE); Nico Fischer, Filderstadt (DE)

(21) Appl. No.: 18/381,190

(22) Filed: Oct. 18, 2023

(30) Foreign Application Priority Data
Sep. 11, 2023 (DE) 102023124459.0

(51) Int. Cl. B05B 11/00

(52) U.S. Cl. CPC B05B 11/0089; B05B 11/0008

(57) ABSTRACT

A dispensing system (1) for a container (2) having a dip tube (5) and being designed for holding stored goods. The dispensing system (1) further has a dispense head (4) which can be fastened to the dip tube (5) so that liquid (3) can be dispensed from the container (2) or liquid (3) can be supplied to the container (2) via the dip tube (5) and the dispense head (4). The dip tube (5) has connection means with a multi-start thread.

### CROSS REFERENCE TO RELATED APPLICATIONS

This application claims the priority of DE 102023124459.0 filed on 2023 Sep. 11; this application is incorporated by reference herein in its entirety.

### BACKGROUND

The invention relates to a dispensing system according to the preamble of claim 1.

Such a dispensing system is known from DE 10 2021 116 140. This dispensing system is used for filling and draining containers, particularly barrels, filled with liquid chemicals. The dispensing system comprises a dispense head, which can be fastened to a dip tube of a container. By means of the dispense head, via the dip tube, liquid can be dispensed from the container or liquid can be supplied to the container.

The dispense head can be fastened to the dip tube by means of a screw connection. For creating this screw connection, the dip tube has a thread. Accordingly, the dispense head has a corresponding mating thread.

Creating the screw connection is relatively cumbersome and time-consuming, as the mating thread must be turned relative to the thread over several revolutions, typically three to four revolutions, to create a stable screw connection.

Another disadvantage is that the thread of the dip tube and the mating thread of the dispense head easily jam. This not only makes it more difficult to create the screw connection. Rather there is a considerable risk of damage to the thread and mating thread. There is a risk of damage in particular if the dip tube with its thread and the dispense head with its mating thread consist of plastic.

### SUMMARY

The invention relates to a dispensing system (1) for a container (2) having a dip tube (5) and being designed for holding stored goods. The dispensing system (1) further has a dispense head (4) which can be fastened to the dip tube (5) so that liquid (3) can be dispensed from the container (2) or liquid (3) can be supplied to the container (2) via the dip tube (5) and the dispense head (4). The dip tube (5) has connection means with a multi-start thread.

### DETAILED DESCRIPTION

The object of the invention is to provide a connection means with a high degree of functionality and functional reliability for a dip tube of the type described above.

The features of the independent claims are provided to solve this problem. Advantageous embodiments of the invention and appropriate further developments are described in the dependent claims.

The invention relates to a dispensing system for a container having a dip tube and being designed for holding stored goods. The dispensing system further has a dispense head which can be fastened to the dip tube so that liquid can be dispensed from the container or liquid can be supplied to the container via the dip tube and the dispense head. The dip tube has connection means with a multi-start thread.

The invention further relates to a dip tube designed for being supported in a container. The dip tube has connection means with a multi-start thread.

According to the invention, a dip tube is provided which is guided into the interior of a container so that stored goods, in particular a liquid, can be dispensed from or supplied to the container via the dip tube. For this purpose, the dip tube is advantageously supported in a container opening of the container so that the dip tube projects into the interior of the container.

According to the invention, the dip tube has a multi-start thread as connection means. With this multi-start thread and a corresponding multi-start thread, i.e. a multi-start mating thread, of another unit, a screw connection can be formed quickly and reliably.

A significant advantage of the multi-start thread according to the invention is that a secure and stable screw connection can be created with only a few revolutions, preferably only one revolution, of the multi-start mating thread relative to the multi-start thread.

A further significant advantage of the multi-start thread according to the invention is that when the multi-start thread is screwed onto the multi-start mating thread, the risk of jamming is considerably reduced compared to conventional single-start threads. Such jamming not only delays the creation of the screw connection, since after jamming the thread must be repositioned on the mating thread. In fact, such jamming bears the risk of damaging the thread and/or the mating thread, so that a screw connection can then no longer be created. This risk exists in particular if the connection means with the multi-start thread and the multi-start mating thread consist of plastic.

According to the invention, the dip tube with the associated container is part of a dispensing system. The dispensing system can comprise a plurality of containers, in each of which a dip tube is supported.

The dispensing system has a dispense head which can be connected to the dip tube of a container in order to dispense stored goods, in particular a liquid, from the container or to supply stored goods to the container. In particular, the fluids may be formed by liquid chemicals.

The dispense head is fastened to the respective dip tube by forming a screw connection, wherein for this purpose the multi-start thread of the dip tube is screwed to a corresponding multi-start thread, i.e. multi-start mating thread, on the dispense head.

After the dispensing or filling process, the dispense head is removed from the dip tube. Then the dip tube and thus the container can be closed with a dip tube closure. The dip tube closure also has a multi-start thread, i.e. multi-start mating thread, corresponding to the multi-start thread of the dip tube, so that the dip tube closure can be screwed tightly to the dip tube.

According to an advantageous embodiment, the multi-start thread of the or each dip tube is designed as an internal thread. Corresponding to this, the multi-start threads of the dispense head and the dip tube closure are designed as external threads.

According to an advantageous embodiment, the connection means of the dip tubes and preferably the entire dip tube consist of plastic.

Furthermore, the connection means of the dispense head and also the connection means of the dip tube closure consist of plastic, wherein the dispense head and the dip tube closure can also consist of plastic in their entirety.

The aforementioned parts can then be manufactured efficiently and cost-effectively as plastic injection molded parts.

Since the connection means consist of plastic, the multi-start threads also consist of plastic. However, this is non-critical because the design of the threads as multi-start threads prevents jamming when creating the screw connection and thus no damage to the multi-start threads is to be feared.

The containers which are designed with the dip tube can be designed in different forms and sizes. In particular, the containers can be designed in the form of bottles or barrels.

Since the screw connections with the multi-start thread can be created and released quickly and without the risk of jamming, robots can be used particularly well for automated creation and release of the screw connections, resulting in a considerable rationalization effect when handling the containers.

According to an advantageous embodiment, an RFID chip, i.e. a transponder, is integrated in each dip tube. This stores identification data of the container and/or of the stored goods in the container.

This data can be read by an RFID reader unit of the dispense head when the dispense head is connected to the dip tube of the container. This prevents mix-ups of containers and the resulting incorrect dispensing of stored goods from the container or incorrect supplying of stored goods to the container. In addition, this ensures traceability of the containers, in particular if the data read out is fed to a central, in particular cloud-based computer system.

### BRIEF DESCRIPTION OF THE DRAWINGS

The invention is explained below on the basis of the drawings. The drawings show:

FIG. 1: Schematic depiction of the dispensing system according to the invention.

FIG. 2: Partial depiction of the dispensing system according to FIG. 1 with a container having a dip tube and a dispense head.

FIG. 3: Enlarged partial depiction of the arrangement according to FIG. 2.

FIG. 4: Individual depiction of a section of the dispense head of the dispensing system according to FIG. 1.

### DETAILED DESCRIPTION OF THE PREFERRED EMBODIMENTS

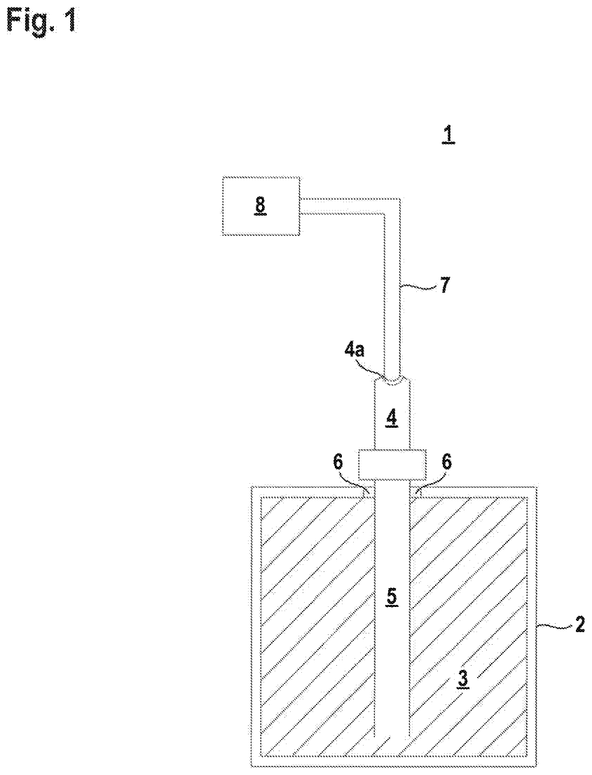

FIG. 1 shows schematically an exemplary embodiment of the dispensing system 1 according to the invention for transportable containers 2, which in particular can be barrels, bottles or similar. A liquid 3 is stored as stored goods in the respective container 2. Liquids 3 stored in such containers 2 are in particular liquid specialty chemicals.

The dispensing system 1 comprises a dispense head 4, which can be fastened to a dip tube 5. The dip tube 5 is supported in a container opening 6 of the container 2, and is thus firmly connected to the container 2. The longitudinal axis of the dip tube 5 projecting into the interior of the container 2 runs in a vertical direction.

The dispense head 4 is used for dispensing liquids 3 from the container 2. Likewise, this can be used for filling containers 2. For this purpose, the dispense head 4 has a liquid connection 4a at its upper end. A line 7 that leads to a pump 8 is connected to this liquid connection 4a. The line 7 can be formed as a hose. The pump 8 is controlled by a control unit (not shown).

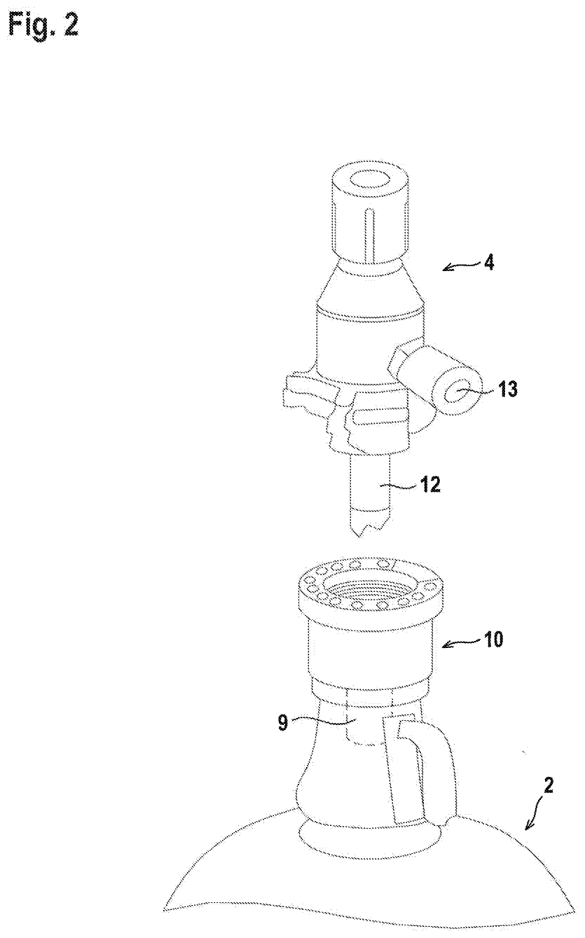

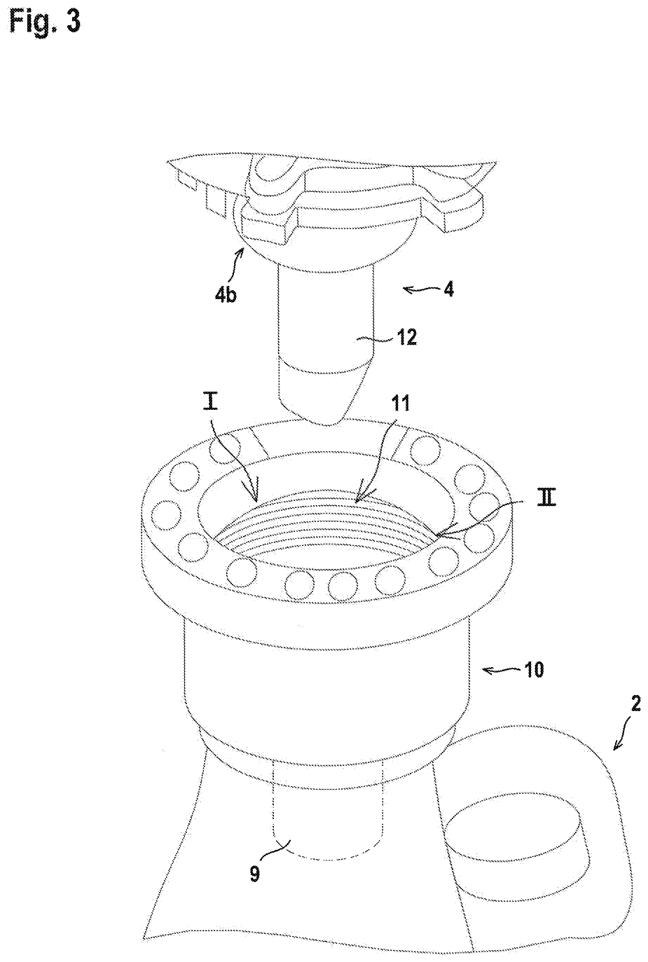

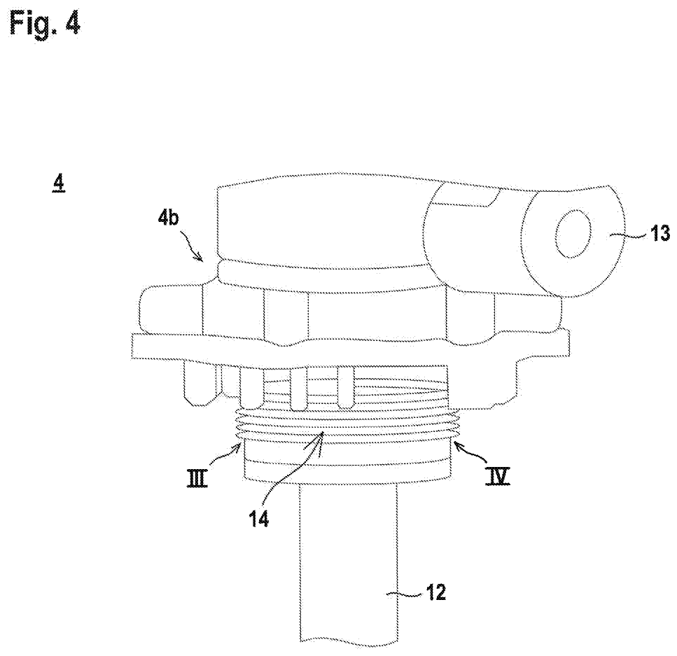

FIGS. 2 and 3 show the dispense head with the associated container 2. FIG. 4 shows an individual depiction of a section of the dispense head 4.

The dip tube 5 has a hollow cylindrical tube body 9 and a head part 10 at the upper side of the tube body 9 (FIGS. 2 and 3). The head part 10 is supported at the container opening at the upper side of the container 2 in such a way that the tube body 9 projects into the container 2. The dip tube 5 consists of plastic.

As shown in FIGS. 2 and 3, the head part 10 has an opening with a circular cross section, which opening opens out at the upper side of the head part 10.

An internal thread 11 is provided as connection means at the inner wall delimiting the opening. Like the rest of the dip tube 5, the connection means with the internal thread 11 consists of plastic.

According to the invention, the internal thread 11 forming the connection means is designed as a multi-start thread, i.e. it has a plurality of cuts, wherein two of these cuts are marked with arrows I, II.

As can be seen in particular from FIGS. 2 and 4, the dispense head 4 has a base body 4b, at the upper end of which the liquid connection 4a is provided. A liquid channel not shown runs inside the base body 4b from the liquid connection 4a, to which liquid channel a tubular lug 12 is connected which opens out at the lower end of the base body 4b. A ventilation port 13 opens out laterally on the base body 4b. The dispense head 4 consists of plastic.

Above the tubular lug 12, at the lower edge of the base body 4b, a connection means is designed in the form of an external thread 14. The external thread 14 is designed complementary to the internal thread 11 of the dip tube 5. These connection means with the external thread 14 also consist of plastic.

The external thread 14 is also designed as a multi-start thread, i.e. it has a plurality of cutouts, wherein two of these cutouts are marked with arrows III, IV.

To mount the dispense head 4 on the dip tube 5, the tubular lug 12 of the dispense head 4 is inserted into the dip tube 5. Then, the external thread 14 of the dispense head 4 is screwed tightly to the internal thread 11 of the dip tube 5, so that a screw connection is formed with which the dispense head 4 is fastened to the dip tube 5.

Since the external thread 14 and internal thread 11 are designed as multi-start threads, a few revolutions, preferably only one revolution, of the external thread 14 on the internal thread 11 are sufficient to form the screw connection firmly and stably. By designing the connection means as multi-start threads, jamming of the external thread 14 on the internal thread 11 is avoided.

The screw connection can advantageously be created and released automatically by means of a robot.

Once the dispense head 4 is fastened to the dip tube 5 by creating the screw connection, a dispensing of liquid 3 from the container 2 can be carried out by using the pump 8 to guide liquid 3 from the container 2 via the dip tube 5, the tubular lug 12 and the liquid channel of the dispense head 4, and to guide it out of the dispense head 4 via the liquid connection 4a. The filling of the container 2 is carried out in a corresponding manner.

An RFID chip, i.e. a transponder (not shown in the Figures), can be integrated in the head part 10 of the dip tube 5. Data which can be used to identify the container 2 and the liquid 3 stored therein are stored in the RFID chip. In the dispense head 4, an RFID reader unit, which is also not shown, is integrated with which the data can be read from the RFID chip when the dispense head 4 is fastened to the dip tube 5 and the RFID chip is thus located within the reading range of the RFID reader unit.

As soon as a dispensing or filling process of the container 2 is completed, the screw connection between the dispense head 4 and the dip tube 5 is released and the dispense head 4 is removed from the dip tube 5. Again, these work steps can be carried out by means of a robot.

A dip tube closure, not shown, is then placed on the head part 10 of the dip tube 5 and fastened there.

The dip tube closure, which advantageously consists of plastic, has an external thread 14 in the form of a multi-start thread which is identical to the external thread 14 of the dispense head 4.

Thus, the dip tube closure can be screwed to the internal thread 11 of the dip tube 5 in the same way as the dispense head 4 with its external thread 14, advantageously again by means of a robot.

### LIST OF REFERENCE NUMERALS

(1) Dispensing system
(2) Container
(3) Liquid
(4) Dispense head
(4a) Liquid connection
(4b) Base body
(5) Dip tube
(6) Line
(7) Line
(8) Pump
(9) Tube body
(10) Head part
(11) Internal thread
(12) Lug
(13) Ventilation port
(14) External thread

1. A dispensing system (1) for a container (2) having a dip tube (5) and designed to hold stored goods, with a dispense head (4) which can be fastened to the dip tube (5) so that liquid (3)
can be dispensed from the container (2) or liquid (3) can be supplied to the container (2) via the dip tube (5) and the dispense head (4), characterized in that the dip tube (5) has a connection means with a multi-start thread.

2. The dispensing system (1) according to claim 1, characterized in that the multi-start thread of the dip tube (5) is part of a screw connection by means of which the dispense head (4) can be fastened to the dip tube (5).

3. The dispensing system (1) according to claim 2, characterized in that the dispense head (4) has connection means with a multi-start thread corresponding to the multi-start thread of the dip tube (5).

4. The dispensing system (1) according to claim 3, characterized in that the multi-start thread of the dip tube (5) is an internal thread (11) and the multi-start thread of the dispense head (4) is an external thread (14).

5. The dispensing system (1) according to claim 1, characterized in that the connection means of the dip tube (5) and of the dispense head (4) consist of plastic.

6. The dispensing system (1) according to claim 5, characterized in that the dip tube (5) consists of plastic.

7. The dispensing system (1) according to claim 5, characterized in that the dispense head (4) consists of plastic parts.

8. The dispensing system (1) according to claim 1, characterized in that the dip tube (5) is supported in a container opening of the container (2) and projects into the interior of the container (2).

9. The dispensing system (1) according to claim 1, characterized in that the container (2) is formed by a bottle or a barrel.

10. The dispensing system (1) according to claim 1, characterized in that an RFID chip is integrated in the dip tube (5), in which RFID chip identification data of the container (2) and/or of the stored goods present in the container (2) are stored.

11. The dispensing system (1) according to claim 1, characterized in that the dispense head (4) can be fastened to the dip tube (5) by means of a robot.

12. A dip tube (5) designed for being supported in a container (2), characterized in that said dip tube (5) has a connection means with a multi-start thread.
